(19) United States
(12) Patent Application Publication
(10) Pub. No.: US 2025/0245782 A1
(43) Pub. Date: Jul. 31, 2025

(54) INFORMATION PROCESSING DEVICE AND IMAGE FORMING APPARATUS FOR ADJUSTING ORIENTATION OF PREVIEW IMAGE AND CAUSING DISPLAY DEVICE TO DISPLAY PREVIEW IMAGE

(71) Applicant: KYOCERA Document Solutions Inc., Osaka (JP)

(72) Inventors: Minori MORIMOTO, Osaka (JP); Shinnosuke YOKOTA, Osaka (JP)

(73) Assignee: KYOCERA Document Solutions Inc., Osaka (JP)

(21) Appl. No.: 19/037,465

(22) Filed: Jan. 27, 2025

(30) Foreign Application Priority Data
Jan. 31, 2024 (JP) 2024-013752

(51) Int. Cl. G06T 3/60; G06T 3/40

(52) U.S. Cl. CPC G06T 3/60; G06T 3/40

(57) ABSTRACT

An information processing device includes a display device and a control device. The control device includes a processor and functions, by the processor executing a control program, as: a controller that causes the display device to display a preview image of an output target image indicated by image data; and a character orientation detector that detects an orientation of characters in the output target image. The controller performs an orientation adjustment display for setting the orientation of the preview image to an orientation in which the orientation of characters detected by the character orientation detector becomes a portrait orientation in which the characters are upright, and displaying the preview image on the display device.

### INCORPORATION BY REFERENCE

This application claims priority to Japanese Patent Application No. 2024-013752 filed on 31 Jan. 2024, the entire contents of which are incorporated by reference herein.

### BACKGROUND

The present disclosure relates to an information processing device and an image forming apparatus.

An information processing device such as an image forming apparatus including a display screen of a rectangular display device having a long side and a short side, which can be rotated between a portrait orientation and a landscape orientation, is known.

For example, a general image forming apparatus including a rectangular display device having a long side and a short side, and a rotation mechanism that can rotate the display device to a portrait orientation in which the long side is positioned vertically and a landscape orientation in which the short side is positioned vertically is known. This general image forming apparatus rotates an orientation of a preview image according to an orientation of the display device, enlarges the preview image, and displays the preview image.

### SUMMARY

As one aspect of the present disclosure, a technology obtained by further improving the above technology is proposed.

An information processing device according to an aspect of the present disclosure includes a display device and a control device. The control device includes a processor and functions, by the processor executing a control program, as: a controller that causes the display device to display a preview image of an output target image indicated by image data; and a character orientation detector that detects an orientation of characters in the output target image. The controller performs an orientation adjustment display for setting the orientation of the preview image to an orientation in which the orientation of characters detected by the character orientation detector becomes a portrait orientation in which the characters are upright, and displaying the preview image on the display device.

An image forming apparatus according to another aspect of the present disclosure includes the information processing device and an image forming device. The image forming device forms an image on a sheet. The controller causes the display device to display, as the preview image, an image serving as an image formation target of the image forming device.

### BRIEF DESCRIPTION OF THE DRAWINGS

FIG. 1 is a front cross-sectional view showing a structure of an image forming apparatus.

FIG. 2 is a functional block diagram schematically illustrating an example of a main internal configuration of the image forming apparatus.

FIG. 3 is a diagram illustrating a state of rotation of a display device.

FIGS. 4A and 4B are diagrams illustrating a state of change in a signal output from a detection sensor.

FIGS. 5A to 5D are diagrams illustrating examples of an output target image.

FIGS. 6A to 6D are diagrams illustrating examples of a preview image displayed on a display device for a landscape orientation.

FIGS. 7A to 7D are diagrams illustrating examples of a preview image displayed on a display device for a portrait orientation.

FIGS. 8A and 9A are diagrams illustrating examples of an output target image in which an orientation of characters is not only one orientation.

FIGS. 8B and 9B are diagrams illustrating a calculation target area of a first calculator.

FIG. 8C is a diagram illustrating another example of the preview image.

FIG. 9C is a diagram illustrating an example of a screen for causing a user to select an orientation of the preview image.

FIGS. 10A and 10B are diagrams illustrating another example of the preview image.

FIG. 11 is a flowchart illustrating an example of a preview display process.

FIG. 12 is a functional block diagram schematically illustrating another example of a main internal configuration of an image forming apparatus.

FIGS. 13A and 14A are diagrams illustrating an example of an output target image including objects other than characters.

FIGS. 13B and 14B are diagrams illustrating a calculation target area of a second calculator.

FIG. 13C is a diagram illustrating another example of the preview image.

FIG. 14C is a diagram illustrating an example of a screen for causing a user to select an orientation of the preview image.

FIGS. 15A and 15B are diagrams illustrating another example of the preview image.

FIGS. 16 and 17 are diagrams illustrating a state where the orientation of the preview image is switched and the preview image is displayed.

FIGS. 18A and 18B are diagrams illustrating examples of a message displayed on the display device.

### DETAILED DESCRIPTION

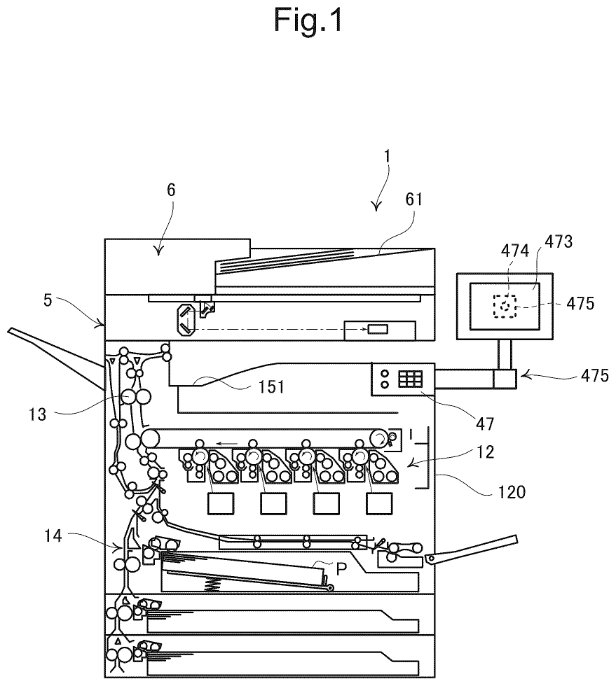

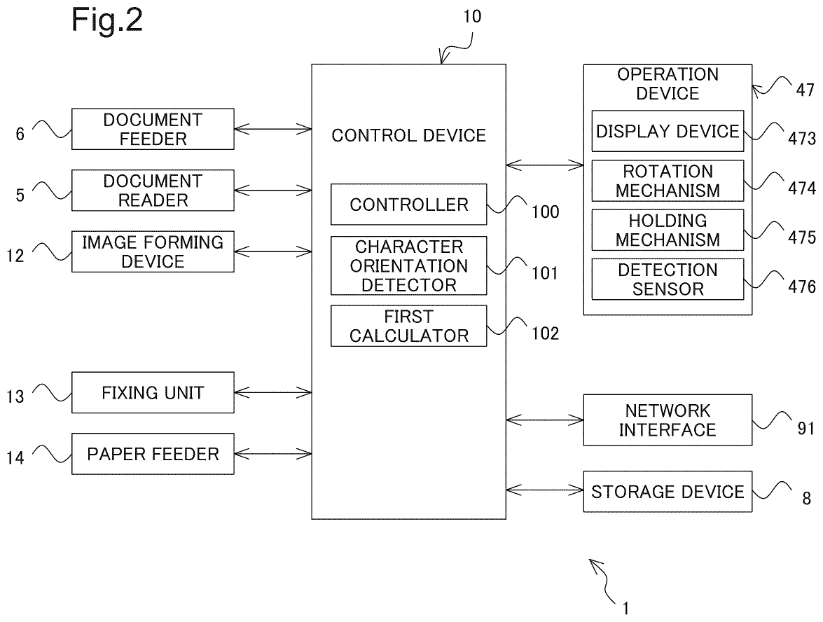

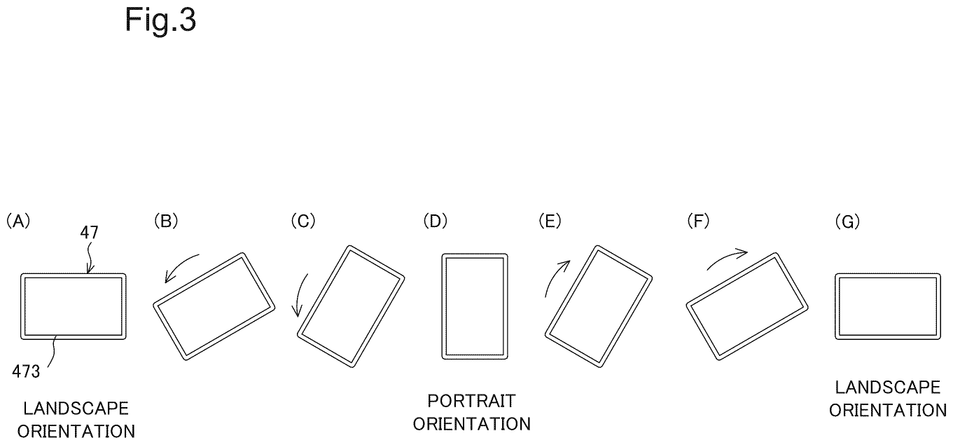

Hereinafter, an information processing device according to an embodiment of the present disclosure will be described with reference to the drawings. The information processing device according to the embodiment of the present disclosure is, for example, an image forming apparatus. FIG. 1 is a front cross-sectional view showing a structure of an image forming apparatus 1 according to first and second embodiments of the present disclosure. FIG. 2 is a functional block diagram schematically illustrating a main internal configuration of the image forming apparatus 1 according to the first embodiment. FIG. 3 is a diagram illustrating a state of rotation of a display device 473.

Hereinafter, left, right, up, and down directions may be indicated, but these directions indicate directions as examples in each drawing unless otherwise specified.

The image forming apparatus 1 is a multifunction device that has a plurality of functions such as a copy function, a printer function, a scanner function, and a facsimile function. The image forming apparatus 1 includes a control device 10, a document feeder 6, a document reader 5, an image forming device 12, a fixing unit 13, a paper feeder 14, an operation device 47, a network interface 91, and a storage device 8.

The document feeder 6 is configured to be openable and closable by means of a hinge or the like on a top surface of the document reader 5. The document feeder 6 functions as a document pressing cover when a document placed on a platen glass is read. The document feeder 6 is an auto document feeder (ADF) and includes a document placement tray 61. The document feeder 6 supplies the document placed on the document placement tray 61 to the document reader 5.

The document reader 5 includes a scanner. The document reader 5 reads the document fed from the document feeder 6 or the document placed on the platen glass.

A document reading operation performed by the image forming apparatus 1 will be described. The document reader 5 optically reads an image of the document fed to the document reader 5 by the document feeder 6 or the document placed on the platen glass, and generates image data. The image data generated by the document reader 5 is stored in an image memory or the like.

The image forming device 12 includes a photoconductor drum, a charging device, an exposure device, a developing device, and a primary transfer device, which correspond to each color. The image forming device 12 also includes a mechanism for forming an image on recording paper P serving as a sheet that is a recording medium through secondary transfer via an intermediate transfer belt.

The paper feeder 14 includes a paper feed cassette, a pickup roller that picks up the recording paper P from the paper feed cassette and feeds the recording paper P to the image forming device 12, a transport roller, a transport path, and a rotation drive mechanism for each roller.

The fixing unit 13 is a fixing device including a heat roller, a pressure roller, and a drive mechanism for driving these rollers to rotate. The fixing unit 13 heats and presses the recording paper P on which a toner image has been formed by the image forming device 12 through the nip between the two rollers, and fixes the toner image onto the recording paper P.

An image forming operation performed by the image forming apparatus 1 will be described. The image forming device 12 forms the toner image on the recording paper P fed from the paper feeder 14 based on the image data generated through the document reading operation, the image data stored in the image memory or the like, image data received from a computer connected to a network, or the like. The fixing unit 13 performs a fixing process on the recording paper P on which the toner image has been formed, to create a printed matter. The recording paper P on which the fixing process has been performed is discharged to a discharge tray 151.

The operation device 47 includes various hard keys that are operated by the user. The operation device 47 receives user instructions, such as an instruction to execute an image forming operation, in response to an operation of the hard keys.

The operation device 47 includes a display device 473 that displays an operation guidance and the like to the user, a rotation mechanism 474, a holding mechanism 475, and a detection sensor 476. The operation device 47 receives user instructions based on user operations (touch operations) with respect to a screen displayed on the display device 473 via a touch panel of the display device 473.

The display device 473 is a rectangular display with a long side and a short side, and includes a liquid crystal display (LCD). When the user touches a button or key displayed on the screen, the touch panel receives an instruction associated with a touched position. The touch panel functions as the operation device.

The holding mechanism 475 is an arm-shaped member that attaches the display device 473 to an apparatus body 120 of the image forming apparatus 1. The holding mechanism 475 supports the display device 473 rotatably relative to the holding mechanism 475, and temporarily fixes and holds the display device 473 in both postures of the landscape orientation and the portrait orientation. The holding mechanism 475 includes engagement portions including a concave portion provided at a position facing the display device 473, at positions corresponding to a landscape posture position and a portrait posture position of the display device 473.

A convex portion fitting into the engagement portion is provided on a side surface of the display device 473 facing the holding mechanism 475. When the display device 473 takes a landscape posture ((A) and (G) of FIG. 3) or a portrait posture ((D) of FIG. 3), the concave portion and the convex portion are fitted together, so that a posture of the display device 473 is fixed and held.

The rotation mechanism 474 is interposed between the holding mechanism 475 and the display device 473. The holding mechanism 475 rotatably supports the display device 473 via the rotation mechanism 474. The rotation mechanism 474 includes a rotation shaft. The rotation shaft is rotatably supported by the holding mechanism 475. The rotation shaft is attached to a rectangular central portion of the side surface of the display device 473 facing the holding mechanism 475 in a state where the rotation shaft rotates together with the display device 473. A cam (which will be described later) that rotates together with the rotation shaft is provided on a circumferential surface of the rotation shaft. The rotation mechanism 474 rotates the display device 473 between a portrait orientation in which the long side of the display device 473 is positioned vertically, and a landscape orientation in which the short side of the display device 473 is positioned vertically.

A state where the display device 473 rotates will be described with reference to (A) to (G) of FIG. 3. The display device 473 in the landscape orientation illustrated in (A) of FIG. 3 rotates counterclockwise to become the portrait orientation, as illustrated in (B) to (D) of FIG. 3. Also, the display device 473 in the portrait orientation illustrated in (D) of FIG. 3 rotates clockwise to become the landscape orientation, as illustrated in (E) to (G) of FIG. 3.

In other words, the rotation mechanism 474 rotates the display device 473 in a counterclockwise direction in FIG. 3 when viewed from a surface of the display device 473, to switch the display device 473 from the landscape orientation to the portrait orientation. A range of rotation angle of the display device 473 is not limited to 90 degrees, but here the range of rotation angle is 90 degrees as an example. However, a rotation orientation of the display device 473 and a configuration for switching the display device 473 from the landscape orientation to the portrait orientation are not limited thereto, and the present embodiment is merely one example.

The detection sensor 476 is a switch mechanism that detects a landscape posture and a portrait posture of the display device 473. The switch mechanism is provided at a position where the switch mechanism is pressed by a cam lobe (convex portion) of a cam attached to the rotation shaft when the display device 473 is in the portrait posture. In other words, the switch mechanism is arranged at a position where the switch mechanism is not pressed by the cam lobe when the display device 473 is at a posture other than the portrait posture. When the switch mechanism is pressed by the cam lobe, the switch mechanism outputs an on signal (low signal) to the control device 10.

As described above, the rotation mechanism 474 has a configuration that the display device 473 is switched from the landscape orientation to the portrait orientation by rotating the display device 473 in the counterclockwise direction in FIG. 3 when viewed from the surface of the display device 473. As the above configuration of the rotation mechanism 474, a configuration in which the cam lobe can enter the switch mechanism only when the display device 473 rotates in a counterclockwise direction, and cannot enter the switch mechanism when the display device 473 rotates in a clockwise direction (for example, a convex portion engaging with the cam lobe is provided on an outer edge of the switch mechanism on an entry path from a clockwise direction to the switch mechanism of the cam lobe) is adopted.

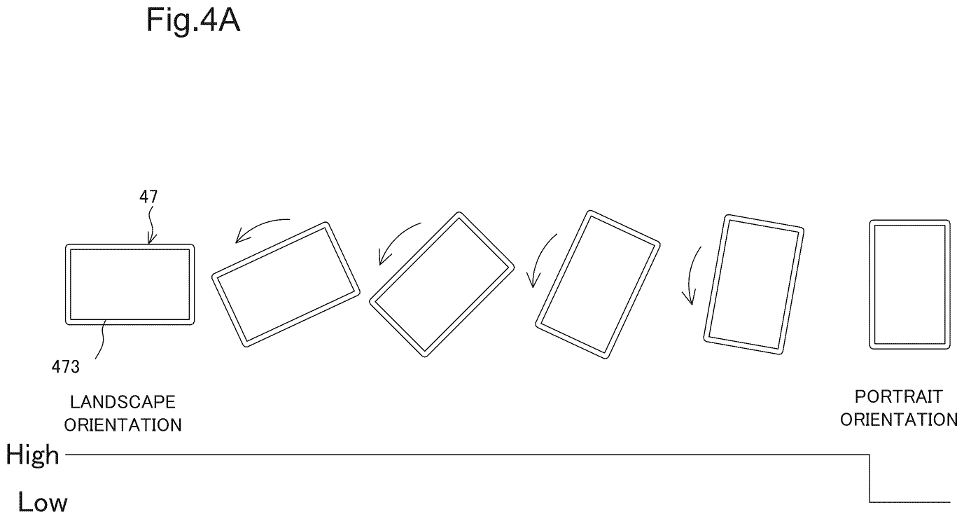

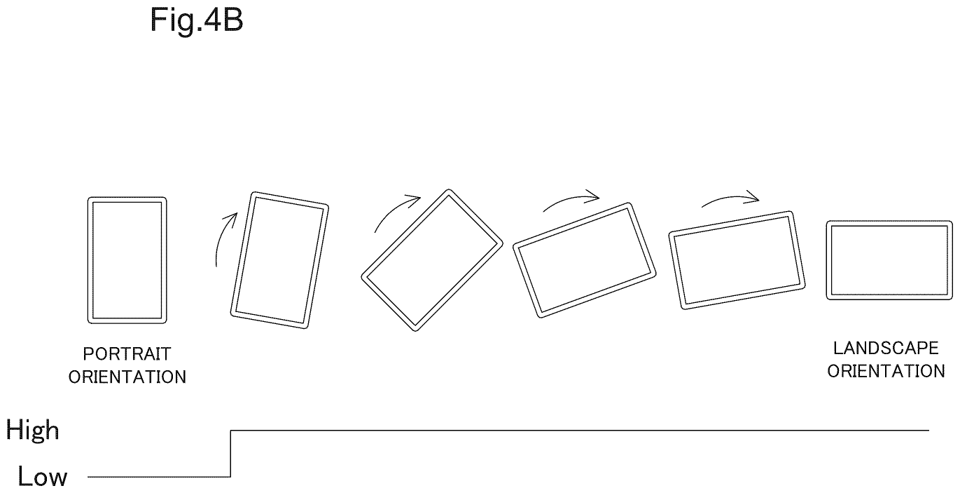

FIGS. 4A and 4B are diagrams illustrating a state of change in the signal output from the detection sensor 476 provided at a position corresponding to the portrait posture of the display device 473. As illustrated in FIGS. 4A and 4B, the detection sensor 476 provided at the position corresponding to the portrait posture of the display device 473 outputs a low signal to the control device 10 when the display device 473 is in the portrait posture (when the switch mechanism is pressed by the cam lobe), and outputs a high signal to the control device 10 otherwise (when the switch mechanism is not pressed by the cam lobe).

Therefore, when the display device 473 takes the portrait orientation illustrated in (D) of FIG. 3, the detection sensor 476 outputs a low signal to the control device 10. When the display device 473 takes a posture other than the portrait orientation illustrated in (D) of FIG. 3, the detection sensor 476 outputs a high signal to the control device 10. Accordingly, the controller 100, which will be described later, determines whether the display device 473 takes the portrait posture or takes a posture other than the portrait orientation, based on the signal output from the detection sensor 476. Specifically, the controller 100 determines that the posture of the display device 473 is the portrait orientation when the display device 473 takes the portrait posture illustrated in (D) of FIG. 3, and determines that the posture of the display device 473 is the landscape orientation when the display device 473 takes other postures.

The network interface 91 is a communication interface that performs transmission and reception of various pieces of data to and from an external device (for example, a personal computer (PC)) within a local area or on the Internet.

The storage device 8 is a large-capacity storage device such as a hard disk drive (HDD) or a solid state drive (SSD), and stores various control programs and the like.

The control device 10 includes a processor, a random access memory (RAM), a read only memory (ROM), and a dedicated hardware circuit. The processor is, for example, a central processing unit (CPU), an application specific integrated circuit (ASIC), or a micro processing unit (MPU).

The control device 10 functions as the controller 100, a character orientation detector 101, and a first calculator 102 through an operation of the processor according to the control program stored in the storage device 8. However, the controller 100 and the like can also be configured of hardware circuits, regardless of the operation according to the control program by the control device 10. Hereinafter, the same applies to respective embodiments unless otherwise stated.

The controller 100 is responsible for an overall operation control of the image forming apparatus 1. The controller 100 is electrically connected to the document feeder 6, the document reader 5, the image forming device 12, the fixing unit 13, the paper feeder 14, the operation device 47, the network interface 91, and the storage device 8, and performs, for example, driving control of each unit. For example, the controller 100 executes various processes required for image formation in the image forming apparatus 1.

The controller 100 performs display control on the display device 473, and displays, for example, a preview image of the output target image indicated by the image data on the display device 473. An image data indicating the output target image is image data obtained through the document reading operation in the document reader 5, image data sent from a PC via the network interface 91, or the like.

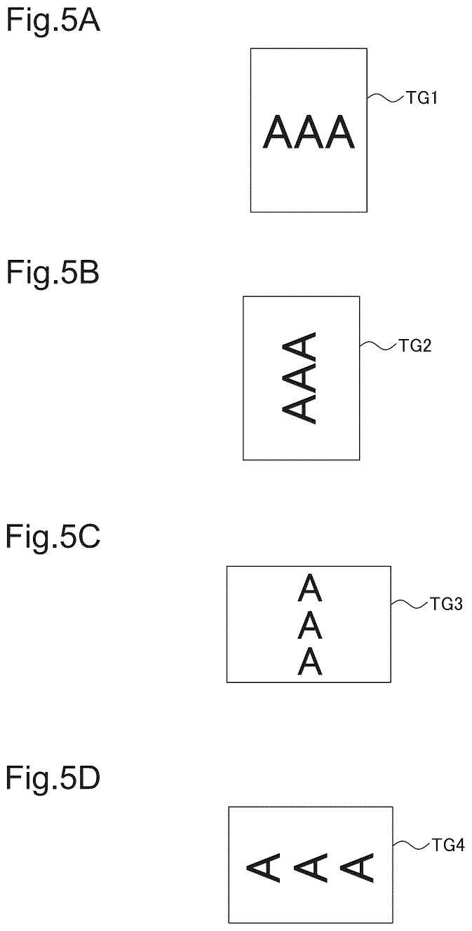

The character orientation detector 101 detects the orientation of characters in the output target image. For example, the character orientation detector 101 detects the orientation of characters in the output target image through a character orientation detection technology using existing optical character recognition (OCR) technology. FIGS. 5A to 5D each show an example of the output target image.

When the preview display targets are the output target images TG1 and TG3 illustrated in FIGS. 5A and 5C, respectively, the character orientation detector 101 detects that the characters in the output target images TG1 and TG3 are the portrait orientation in which a posture of the characters is upright. When the preview display target is the output target images TG2 and TG4 illustrated in FIGS. 5B and 5D, respectively, the character orientation detector 101 detects that the characters in the output target images TG2 and TG4 are a landscape orientation (an orientation tilted to the left in FIGS. 5B and 5D) 90 degrees different from the portrait orientation. In other words, in the present embodiment, the orientation of characters that are upright is defined as a portrait orientation.

The controller 100 sets the orientation of the preview image as an orientation in which the orientation of the characters detected by the character orientation detector 101 is a portrait orientation, and performs orientation adjustment display to display the preview image on the display device 473. The controller 100 performs size adjustment display for adjusting the size of the preview image according to the orientation of the display device 473 detected by the detection sensor 476 and causing the display device 473 to display the preview image. Here, the orientation of the preview image includes a portrait orientation in which the long side is positioned vertically and a landscape orientation in which the short side is positioned vertically.

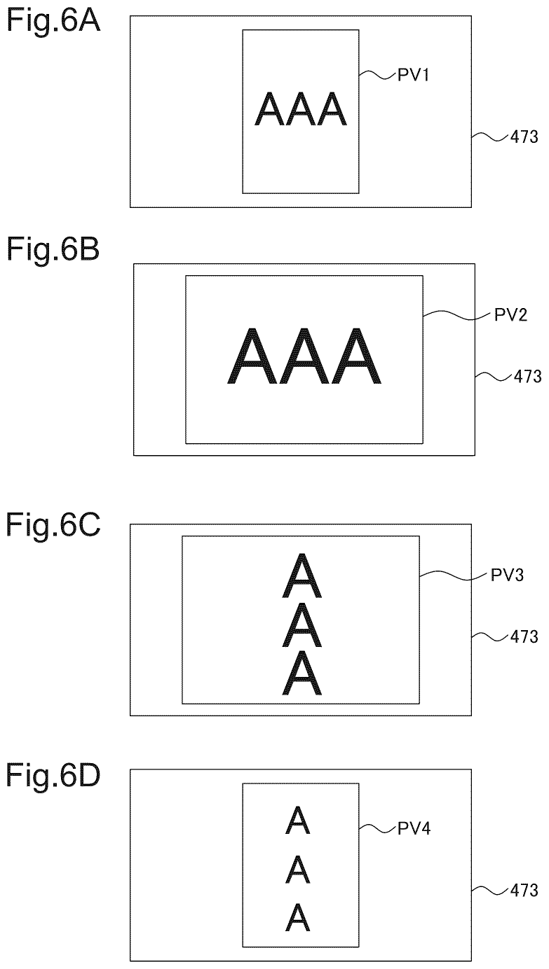

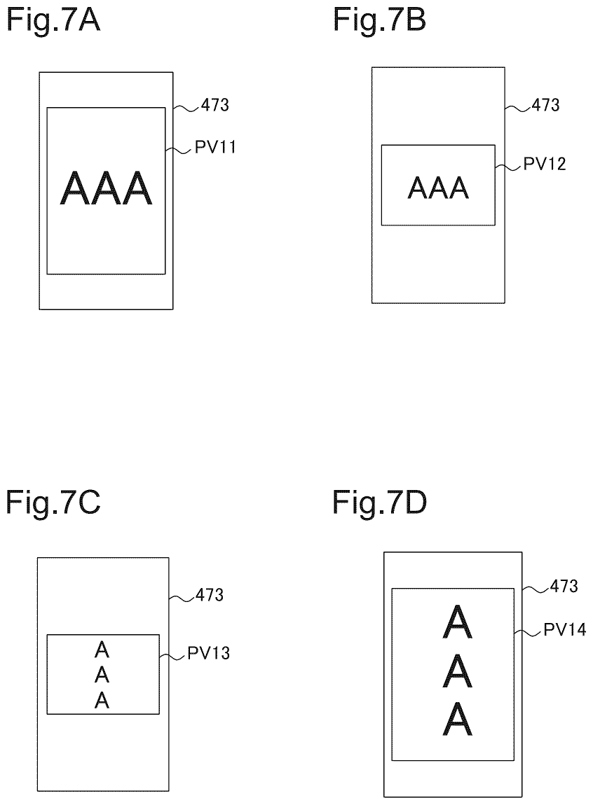

For example, in a case where a preview display of the output target images TG1 to TG4 shown respectively in FIGS. 5A to 5D is performed, the controller 100 causes the display device 473 to display the respective preview images PV1 to PV4, as shown in the examples in FIGS. 6A to 6D when the display device 473 is a landscape orientation. When the display device 473 is a portrait orientation, the controller 100 causes the display device 473 to display the preview images PV11 to PV14, as shown in the examples of FIGS. 7A to 7D.

Since characters in an output target image TG2 illustrated in FIG. 5B are not a portrait orientation, but is the landscape orientation in which the characters are tilted to the left by 90 degrees counterclockwise from the portrait orientation, the controller 100 rotates the preview image of the output target image TG2 by 90 degrees clockwise, and causes the display device 473 to display the preview images PV2 and PV12 as illustrated in FIGS. 6B and 7B.

Similarly, since characters in the output target image TG4 illustrated in FIG. 5D are not the portrait orientation, but the landscape orientation in which the characters are tilted to the left, the controller 100 rotates the preview image of the output target image TG4 by 90 degrees clockwise and causes the display device 473 to display the preview images PV4 and PV14 as illustrated in FIGS. 6D and 7D.

When the display device 473 is the landscape orientation and the preview image is also the landscape orientation after the rotation of the preview image, the controller 100 causes the display device 473 to display the preview images PV2 and PV3 enlarged to a maximum size that can be displayed on the display screen, after maintaining the aspect ratio, according to the size of the display area of the display screen of the display device 473 of the landscape orientation, as illustrated in FIGS. 6B and 6C.

When the display device 473 is the portrait orientation and the preview image is the portrait orientation, the controller 100 causes the display device 473 to display the preview images PV11 and PV14 enlarged to the maximum size that can be displayed on the display screen after maintaining the aspect ratio according to the size of the display area of the display screen of the display device 473 of the portrait orientation, as illustrated in FIGS. 7A and 7D.

The first calculator 102 calculates a size of the character area in which characters are arranged in the output target image, for each of character areas with different character orientations, based on a detection result of the character orientation detector 101. For example, the first calculator 102 calculates a size of a first character area indicating the character area in the output target image of a group of characters facing a predetermined first orientation, and a size of a second character area indicating the character area in the output target image of a group of characters facing a second orientation that is 90 degrees different from the first orientation, based on the detection result of the character orientation detector 101.

Here, the size of the character area is assumed to be an area. In other words, the first calculator 102 calculates a sum of areas of the areas in which characters with the same character orientation are displayed, as the area of the character area of the group of characters in the orientation. In this case, the areas of the respective characters with the same orientation may be scattered, or the areas of the characters may be consecutively grouped together to form one area. The first calculator 102 may detect the character area without including characters that are equal to or smaller than a predetermined size.

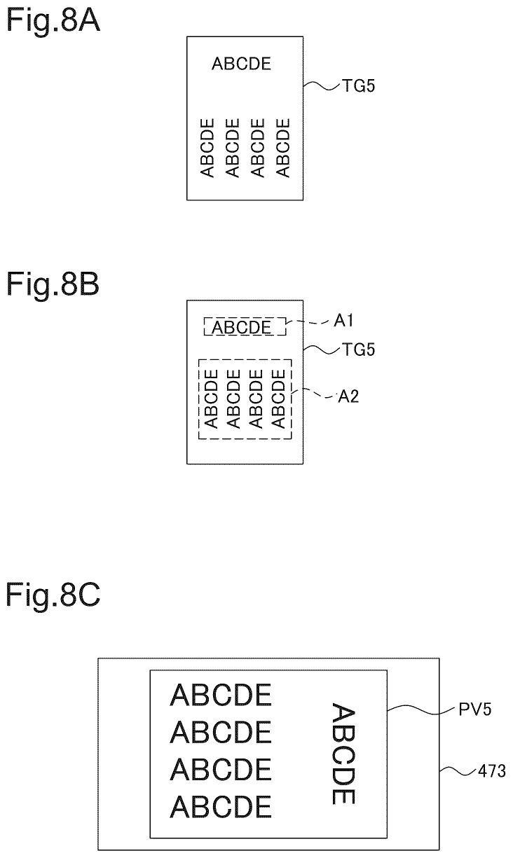

FIG. 8A shows an example of the output target image in which the orientation of the characters is not only one orientation. For example, the first calculator 102 analyzes image data indicating the output target image TG5 illustrated in FIG. 8A, and calculates a size (area) of a first character area A1 including characters facing an upward direction in the output target image TG5, and a size (area) of a second character area A2 including characters facing a left direction in the output target image TG5, as shown in the example of FIG. 8B.

The controller 100 sets the orientation of the preview image as an orientation in which an orientation of characters included in a character area in which the size calculated by the first calculator 102 is largest is portrait orientation, and performs the orientation adjustment display to cause the display device 473 to display the preview image. For example, when the first character area A1 is larger than the second character area A2, the controller 100 sets the orientation of the preview image so that the orientation of the characters facing the first orientation is the portrait orientation. On the other hand, when the second character area A2 is larger than the first character area A1, the controller 100 sets the orientation of the preview image so that the orientation of the characters facing the second orientation is the portrait orientation.

For example, as illustrated in FIG. 8B, when the size of the second character area A2 is larger than the size of the first character area A1, the controller 100 sets the orientation of the preview image so that the orientation of the characters facing the second orientation is the portrait orientation. In FIG. 8C, the controller 100 causes the display device 473 to display the preview image PV5 enlarged to the maximum size that can be displayed on the display screen after maintaining the aspect ratio according to the size of the display area of the display screen of the display device 473 of the landscape orientation.

When a difference in size between the first character area A1 and the second character area A2 is within a predetermined range (for example, when the size of the first character area A1/(the size of the first character area A1+the size of the second character area A2) is within a range of 45% to 55%), the controller 100 sets the orientation of the preview image to an orientation in which any one of the orientation of the characters facing the first orientation and the orientation of the characters facing the second orientation, which is indicated by the user instruction received by the operation device 47, becomes the portrait orientation.

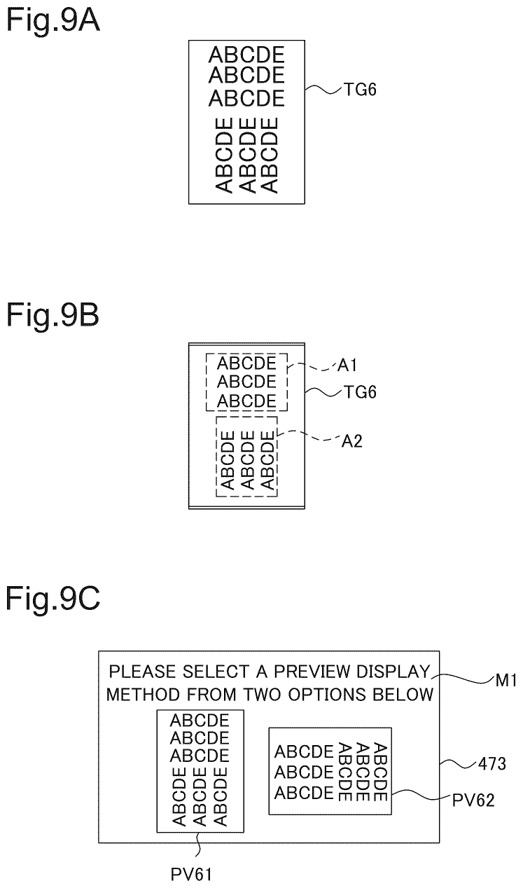

FIG. 9A shows another example of the output target image in which the orientation of the characters is not one orientation. When the difference in size between the first character area A1 and the second character area A2 in the output target image TG6 is within a predetermined range as illustrated in FIG. 9B, the controller 100 sets the orientation of the preview image to an orientation in which any one of the first character area A1 having the orientation of the characters facing the first orientation and the second character area A2 having the orientation of the characters facing the second orientation is the portrait orientation, according to the instruction received by the operation device 47.

As shown in the example in FIG. 9C, the controller 100 iconizes a preview image PV61 when a process in which the first character area A1 becomes the portrait orientation has been performed, and a preview image PV62 when a process in which the second character area A2 becomes the portrait orientation has been performed and causes the display device 473 to display icons, and displays a message M1 stating “Please select a preview display method from two options below” on the display device 473.

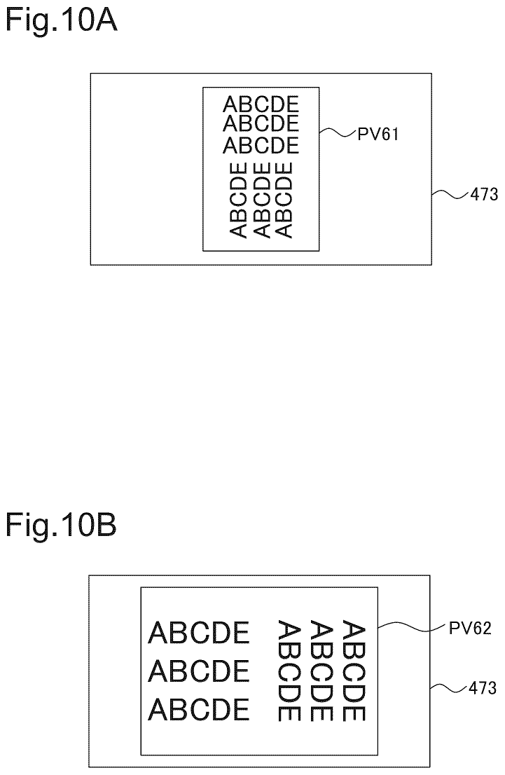

When the operation device 47 receives a user selection instruction for the preview image PV61 (an instruction to request execution of a first orientation adjustment display), the controller 100 causes the display device 473 to display the preview image PV61 as illustrated in FIG. 10A. On the other hand, when the operation device 47 receives a user selection instruction for the preview image PV62 (an instruction to request execution of a second orientation adjustment display), the controller 100 causes the display device 473 to display the preview image PV62 as illustrated in FIG. 10B.

In this case, the controller 100 also causes the display device 473 to display a preview image enlarged to the maximum size that can be displayed on the display screen, after maintaining the aspect ratio, according to the size of the display area on the display screen according to the orientation of the display device 473.

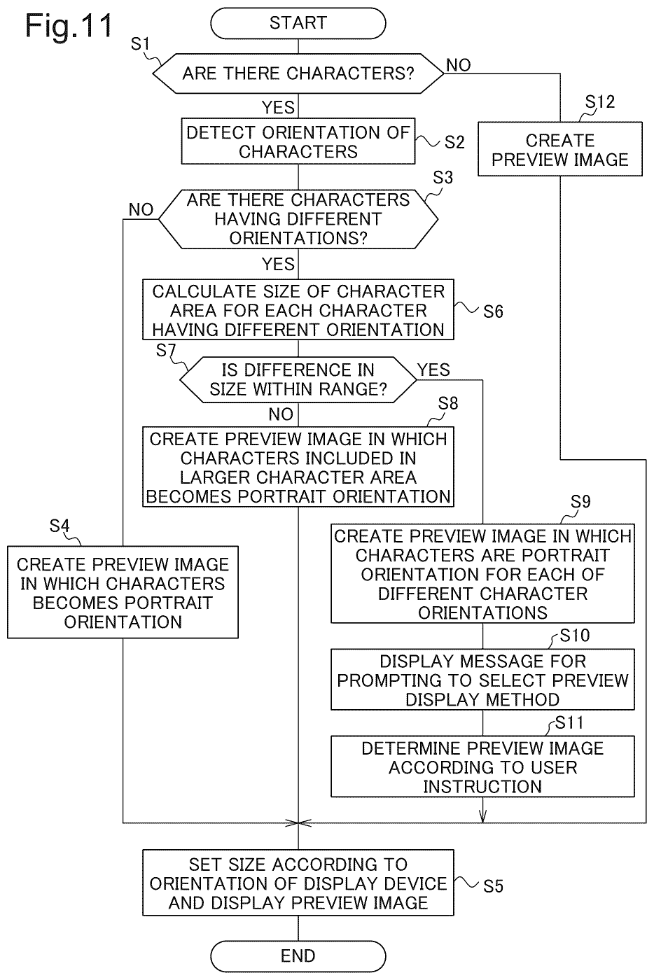

Next, a preview display process in the image forming apparatus 1 will be described. FIG. 11 is a flowchart illustrating an example of the preview display process.

The controller 100 determines whether or not there are characters in the output target image using known OCR technology, edge detection technology, or the like, based on the image data indicating the output target image (step S1). When the controller 100 determines that there are the characters in the output target image (YES in step S1), the character orientation detector 101 detects an orientation of the characters in the output target image (step S2).

For example, at the time of the process of step S1, the character orientation detector 101 performs character discrimination processing using OCR technology from top, bottom, left, and right directions on the image data indicating the output target image, stores the orientation recognized as a character for each character, and reads the orientation of each character in step S2.

The controller 100 determines whether or not there are characters having different orientations in the output target image, based on a detection result of the character orientation detector 101 (step S3). When the controller 100 determines that there are no characters having different orientations in the output target image (the orientation is only one orientation) (NO in step S3), the controller 100 sets the orientation of the preview image to an orientation in which the orientation of the characters detected by the character orientation detector 101 becomes the portrait orientation in which the characters are upright, and creates a preview image of the output target image (step S4).

The controller 100 causes the display device 473 to display a preview image obtained by enlarging the created preview image to the maximum size that can be displayed on the display screen, after maintaining the aspect ratio according to the size of the display area on the display screen, according to the orientation of the display device 473 detected by the detection sensor 476 (step S5). After step S5, the controller 100 ends the preview display process.

On the other hand, when the controller 100 determines that there are characters having different orientations in the output target image (YES in step S3), the first calculator 102 calculates a size of each character area for each character having a different orientation based on the detection result of the character orientation detector 101 (step S6).

The controller 100 determines whether the difference in size of each character area is within a predetermined range based on a calculation result of the first calculator 102 (step S7). Here, an example in which a determination is made whether the difference in size between the first character area A1 in which the character orientation is the first orientation and the second character area A2 in which the character orientation is the second orientation, is within the predetermined range will be described.

When the controller 100 determines that the difference in size between the two areas is not within the predetermined range (one of the areas is too large) (NO in step S7), the controller 100 creates a preview image of the output target image so that the orientation of the characters included in the larger character area becomes the portrait orientation (step S8).

The controller 100 causes the display device 473 to display a preview image whose size has been adjusted according to the orientation of the display device 473 detected by the detection sensor 476 (step S5). After step S5, the controller 100 ends the preview display process.

On the other hand, when the controller 100 determines that the difference in size between the two areas is within the predetermined range (the two areas are substantially the same) (YES in step S7), the controller 100 creates a preview image of the output target image so that the orientation of the characters is the portrait orientation, for each of the different orientations (step S9).

The controller 100 causes the display device 473 to display the created preview images side by side and causes the display device 473 to display the message M1 for prompting the user to input an instruction indicating the preview image to be selected, as shown in the example of FIG. 9C (step S10). The controller 100 determines the preview image according to the selection instruction received by the operation device 47 (step S11).

The controller 100 adjusts the size of the preview image indicated by the user selection instruction received by the operation device 47 according to the orientation of the display device 473 detected by the detection sensor 476, and causes the display device 473 to display the adjusted preview image (step S5). After step S5, the controller 100 ends the preview display process.

When the controller 100 determines in step S1 that there are no characters in the output target image (NO in step S1), the controller 100 creates a preview image of the output target image with an orientation of the output target image unchanged (step S12), adjusts the size of the preview image according to the orientation of the display device 473 detected by the detection sensor 476, and causes the display device 473 to display the adjusted preview image (step S5). After step S5, the controller 100 ends the preview display process.

Incidentally, there is known an image forming apparatus having a preview function of causing a display device to display a preview image of an output target image (for example, an image showing a finished image of the printed matter). When the display device is caused to display the preview image, for example, the user can confirm a finished print state in advance.

However, since the preview image cannot be displayed to be very large, it is not easy for the user to confirm details of the finished image of the printed matter. In particular, if the characters in the preview image are not the portrait orientation in which the characters are upright, but the landscape orientation in which the characters are horizontal tilted, it is difficult to decipher and recognize the characters, when the preview image is displayed.

On the other hand, according to the first embodiment, since the preview image whose orientation has been adjusted so that the orientation of the characters in the output target image is the portrait orientation is displayed on the display device 473, it is easier for the user to confirm the details of the preview image. That is, the visibility of the characters in the preview image is improved when the preview image is displayed. Further, since the size of the preview image can be enlarged according to the orientation of the display device 473, the visibility can be further improved.

Incidentally, the output target image may contain objects (for example, photographs, graphic images, or diagrams) other than the characters. When a proportion of the objects other than the characters in the output target image is greatly lower than a proportion of characters, it is preferable to adjust the orientation of the preview image according to the orientation of the characters.

However, when the proportion of the objects other than the characters is similar to that of the characters, there is concern that the visibility of the objects may be degraded if the orientation of the preview image is changed according to the orientation of the characters. Therefore, as a second embodiment, an embodiment in which the presence of a display area for objects other than characters is considered and then the orientation of the preview image is set will be described.

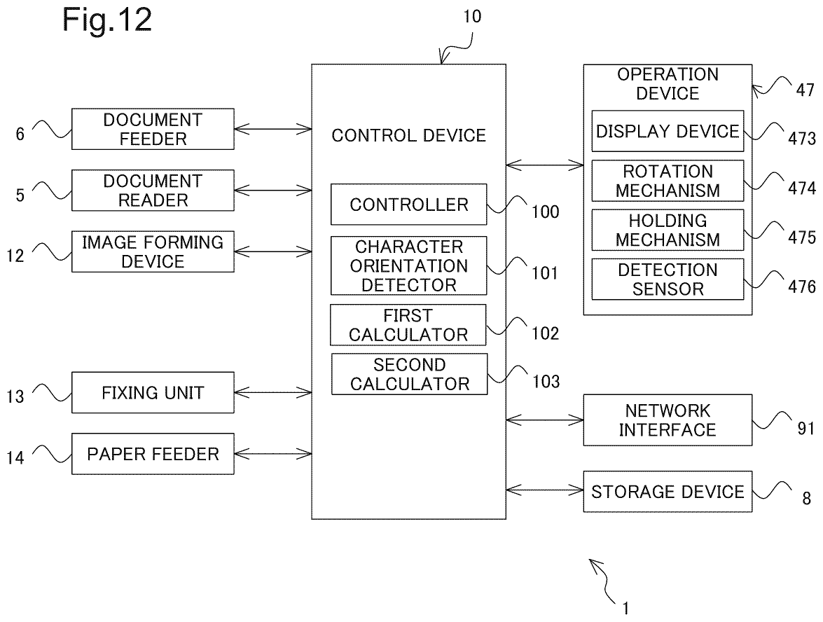

FIG. 12 is a functional block diagram schematically illustrating an overview of a main internal configuration of the image forming apparatus 1 according to the second embodiment. In the second embodiment, the control device 10 functions as a second calculator 103 in addition to the controller 100, the character orientation detector 101, and the first calculator 102 according to an operation of the processor according to the control program stored in the storage device 8. Hereinafter, a configuration and process different from those in the first embodiment illustrated in FIG. 2 will be described.

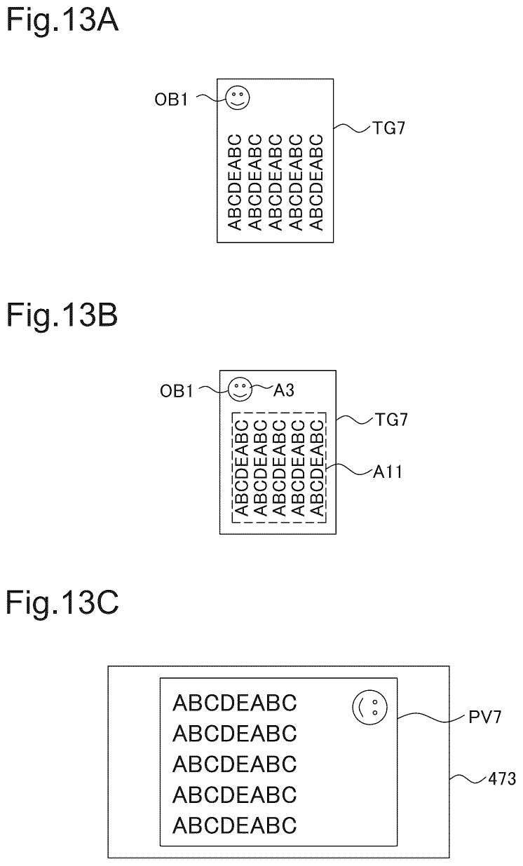

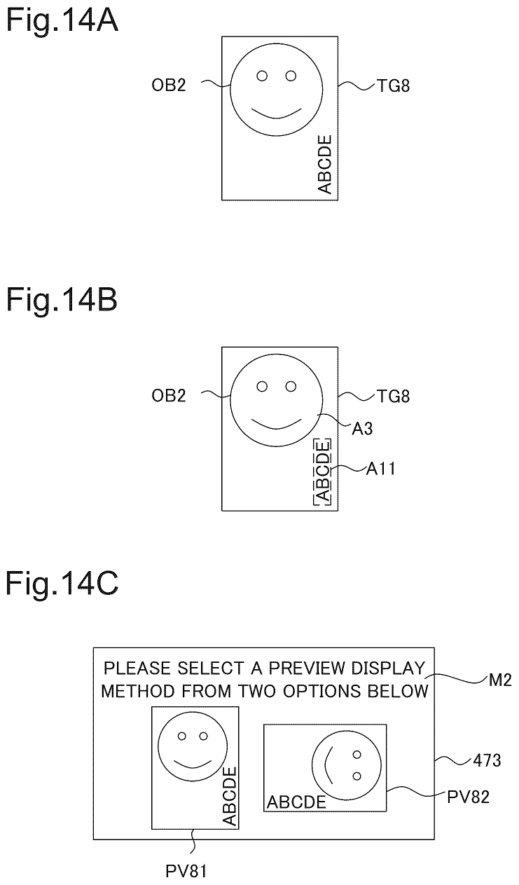

The second calculator 103 calculates the size of the display area for objects other than characters in the output target image. FIGS. 13A and 14A show examples of output target images including objects other than characters. Output target images TG7 and TG8 illustrated in FIG. 13A and FIG. 14A include objects OB1 and OB2 other than the characters, respectively.

The second calculator 103, for example, divides the objects included in the output target image into a character area and an object area including images other than characters using a known area determination technology, detects a display area A3 of the objects OB1 and OB2 other than characters as illustrated in FIG. 13B and FIG. 14B, and calculates a size (area) of the detected display area A3.

When a size of an object area A3 including the objects other than characters calculated by the second calculator 103 is equal to or smaller than a predetermined threshold, the controller 100 performs a process of setting the orientation of the preview image according to the orientation of the characters (the orientation adjustment display).

As the predetermined threshold, for example, a ratio (for example, 50%) of the display area A3 to the entire output target image, or a ratio of the display area A3 (for example, 50%) to the display area of all the objects (a display area that is a combination of the character display area A11 and the non-character display area A3) is adopted.

For example, when the display area A3 of the non-character object OB1 is equal to or smaller than the predetermined threshold (50% of the entire output target image) with respect to the display area of all the objects as illustrated in FIG. 13B, the controller 100 sets the orientation of the preview image so that the characters are a portrait orientation, adjusts a size of a preview image PV7 to a size according to the orientation of the display device 473 as illustrated in FIG. 13C, and causes the display device 473 to display the preview image.

On the other hand, when the size of the display area of the non-character object is larger than the predetermined threshold, the controller 100 causes the display device 473 to display the preview image with the orientation of the output target image unchanged.

Alternatively, when the size of the display area of the object other than the characters is larger than the predetermined threshold, the controller 100 executes a process indicated by the user instruction received by the operation device 47 between a process of displaying a preview image with the orientation of the output target image unchanged and a process of changing the orientation of the preview image according to the orientation of the characters.

For example, as illustrated in FIG. 14B, when the display area A3 of the object OB2 other than the characters is larger than 50% of the display area of all the objects, the controller 100 iconizes a preview image PV81 with an orientation of an output target image TG8 unchanged, and a preview image PV82 with an orientation set according to the orientation of the characters to display icons, as illustrated in FIG. 14C, and causes the display device 473 to display a message M2 stating “Please select a preview display method from two options below.”

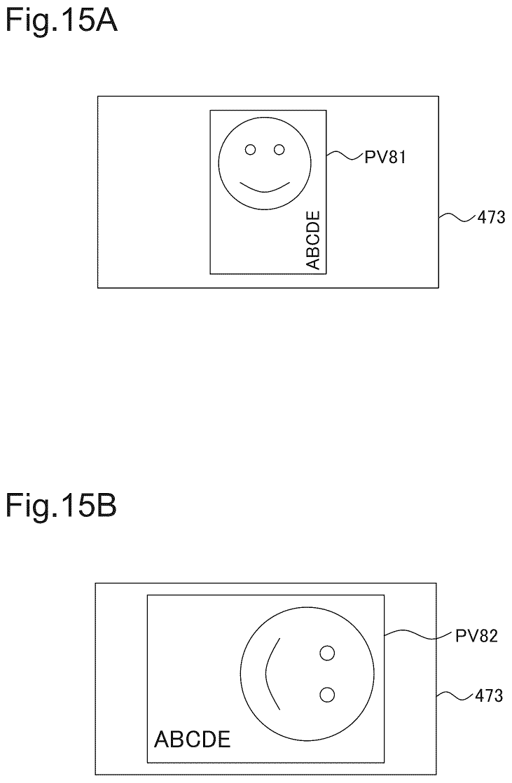

When the operation device 47 receives an instruction from the user to select the preview image PV81 (an instruction to request execution of normal display), the controller 100 causes the display device 473 to display the preview image PV81 as illustrated in FIG. 15A. On the other hand, when the operation device 47 receives an instruction from the user to select the preview image PV82 (an instruction to request execution of a process of changing the orientation of the preview image according to the orientation of the characters), the controller 100 causes the display device 473 to display the preview image PV82 as illustrated in FIG. 15B.

For the preview display of the output target image, the controller 100 may perform a preview display (normal display) with the orientation of the output target image unchanged, and then, perform a preview image display with an orientation set according to the orientation of the characters, according to the user instruction received by the operation device 47.

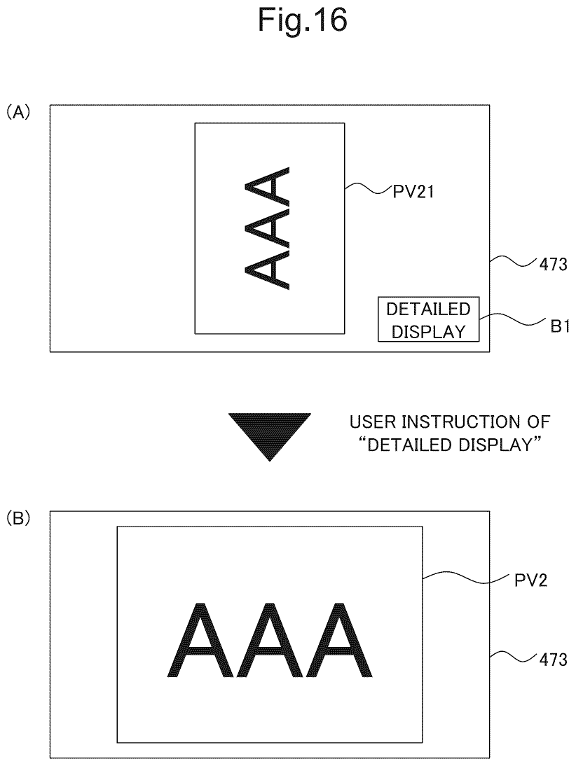

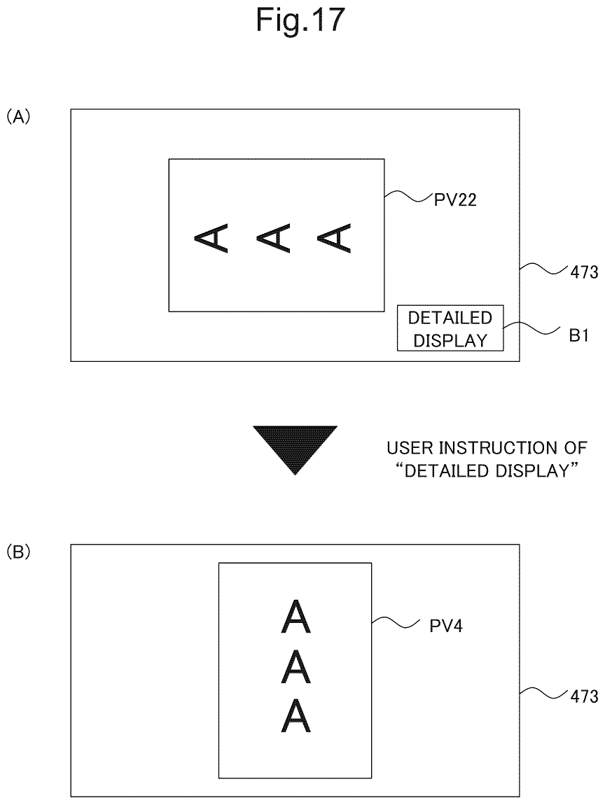

For example, the controller 100 causes the display device 473 to display an operation button B1 marked “Detailed Display” together with the preview images PV21 and PV22, as illustrated in (A) of FIG. 16 and (A) of FIG. 17. When the operation device 47 receives an orientation adjustment instruction in response to a user operation with respect to the operation button B1, the controller 100 causes the display device 473 to display the preview images PV2 and PV4, as illustrated in (B) of FIG. 16 and (B) of FIG. 17.

The preview images PV21 and PV2 illustrated in (A) and (B) of FIG. 16 are preview images of the output target image TG2 illustrated in FIG. 5B. The preview images PV22 and PV4 illustrated in (A) and (B) of FIG. 17 are preview images of the output target image TG4 illustrated in FIG. 5D.

Incidentally, since the display device 473 is the landscape orientation, the preview image PV2 in the landscape orientation can be displayed to be relatively large as illustrated in (B) of FIG. 16, but the preview image PV4 in the portrait orientation cannot be displayed to be large as illustrated in (B) of FIG. 17. Therefore, when the preview image PV4 in the portrait orientation is displayed on the display device 473, it is preferable to set the display device 473 to the portrait orientation.

Therefore, as a third embodiment, the controller 100 determines whether the preview image is the portrait orientation or the landscape orientation, compares the orientation of the display device 473 with the orientation of the preview image based on a determination result, and causes the display device 473 to display a message regarding changing the orientation of the display device 473 based on whether the two orientations match or do not match.

For example, when the controller 100 sets the orientation of the preview image according to the orientation of the characters as the orientation adjustment display, the controller 100 causes the display device 473 to display a message for prompting the user to rotate the display device 473 in a case where the orientation of the display device 473 detected by the detection sensor 476 does not match the orientation of the preview image that is the portrait orientation in which the characters are upright.

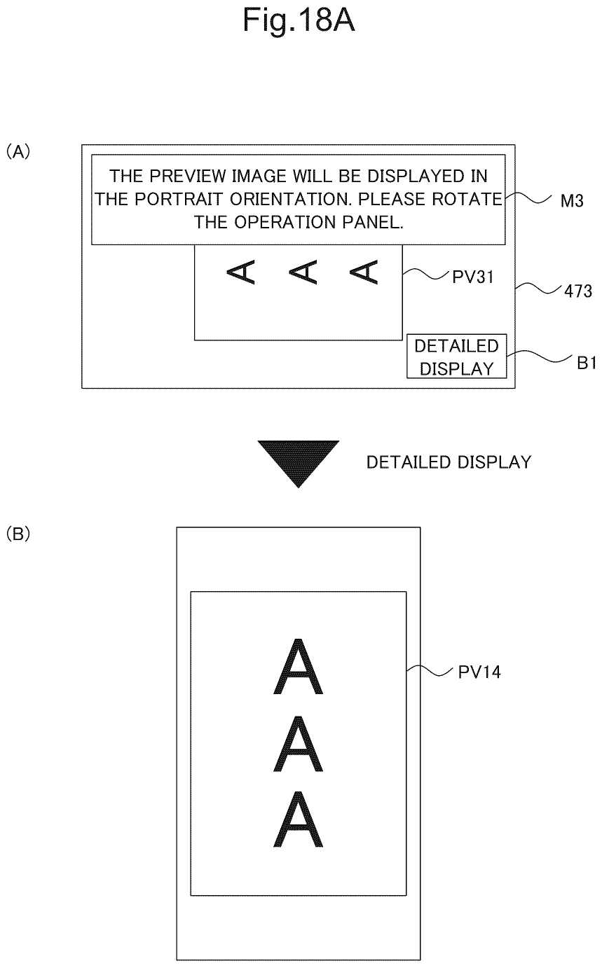

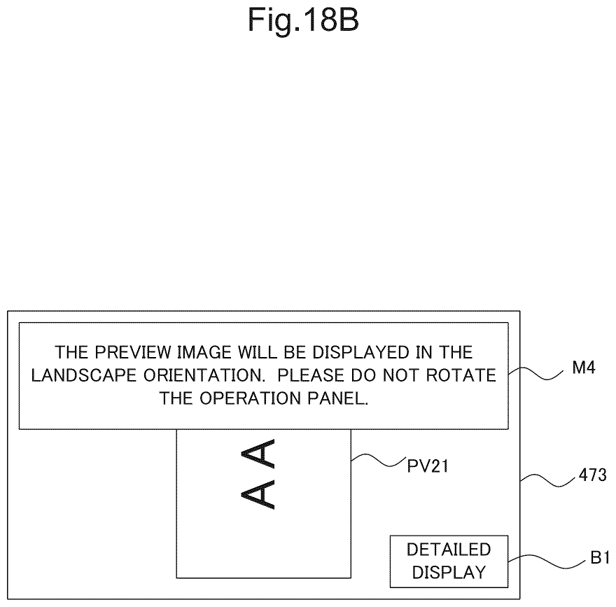

For example, if the operation device 47 receives an instruction for the operation button B1 when the display device 473 is displaying the content illustrated in (A) of FIG. 17, the controller 100 causes the display device 473 to display a message M3 stating “The preview image will be displayed in the portrait orientation. Please rotate the operation panel.”, as shown in the example of (A) of FIG. 18A.

When the user rotates the display device 473 from the landscape orientation to the portrait orientation, the controller 100 greatly enlarges the preview image PV4 of the output target image TG4 and causes the display device 473 to display the preview image PV4, as illustrated in (B) of FIG. 18A. This motivates the user to rotate the display device 473, making it easier to perform processing for improving the visibility of the preview image.

On the other hand, when the controller 100 sets the orientation of the preview image according to the orientation of the characters as the orientation adjustment display, the controller 100 causes the display device 473 to display a message for prompting the user not to rotate the display device 473 in a case where the orientation of the display device 473 detected by the detection sensor 476 matches the orientation of the preview image that becomes the portrait orientation in which the characters are upright.

For example, when the controller 100 is causing the display device 473 to display the content illustrated in (A) of FIG. 16, if the operation device 47 receives an instruction with respect to the operation button B1, the controller 100 causes the display device 473 to display a message M4 stating “The preview image will be displayed in the landscape orientation. Please do not rotate the operation panel.” as shown in an example of FIG. 18B. This prevents a process of improving the visibility of the preview image from being not performed by the user rotating the display device 473 even though the process of improving the visibility of the preview image is being performed.

The present disclosure is not limited to the configuration of the embodiment and various modifications can be made. Further, the configuration and the process shown in the embodiment using FIG. 1 to FIG. 18B are merely one embodiment of the present disclosure, and it is not intended that the present disclosure be limited to the configuration and process.

While the present disclosure has been described in detail with reference to the embodiments thereof, it would be apparent to those skilled in the art the various changes and modifications may be made therein within the scope defined by the appended claims.

What is claimed is:

1. An information processing device comprising:
a display device; and
a control device including a processor and functioning, by the processor executing a control program, as:
a controller that causes the display device to display a preview image of an output target image indicated by image data, by the processor executing a control program; and
a character orientation detector that detects an orientation of characters in the output target image, wherein
the controller performs an orientation adjustment display for setting the orientation of the preview image to an orientation in which the orientation of characters detected by the character orientation detector becomes a portrait orientation in which the characters are upright, and displaying the preview image on the display device.

2. The information processing device according to claim 1, wherein
the control device further functions as a first calculator that calculates a size of a character area in which the characters are arranged in the output target image for each character area with different character orientations, based on a detection result of the character orientation detector, and
the controller sets the orientation of the preview image to an orientation in which the orientation of characters included in the character area with a largest size calculated by the first calculator becomes a portrait orientation in the orientation adjustment display.

3. The information processing device according to claim 2, wherein
the first calculator calculates a size of a first character area in which a first character detected to face a predetermined first orientation by the character orientation detector is arranged, and a size of a second character area in which a second character detected to face a second orientation 90 degrees different from the first orientation by the character orientation detector is arranged, in the output target image, and
the controller sets the orientation of the preview image to an orientation in which an orientation of the first character becomes the portrait orientation when the size of the first character area is larger than the size of the second character area, and sets the orientation of the preview image to an orientation in which an orientation of the second character becomes the portrait orientation when the size of the second character area is larger than the size of the first character area in the orientation adjustment display.

4. The information processing device according to claim 3, further comprising an operation device to which a user instruction is input, wherein
the controller sets the orientation of the preview image to an orientation in which any one of the orientation of the first character and the orientation of the second character becomes the portrait orientation according to an instruction received via the operation device when a difference between the size of the first character area and the size of the second character area is within a predetermined range.

5. The information processing device according to claim 2, wherein the first calculator detects the character area without including characters having a size equal to or smaller than a predetermined size.

6. The information processing device according to claim 1, further comprising an operation device to which a user instruction is input, wherein
the control device further functions as a second calculator that calculates a size of an object area in which objects other than the characters are arranged in the output target image, and
the controller
performs the orientation adjustment display according to an orientation of the characters when the size of the object area is equal to or smaller than a predetermined threshold, and
causes the display device to display the preview image with the orientation unchanged when the size of the object area is larger than the predetermined threshold.

7. The information processing device according to claim 6, wherein, when the size of the object area is larger than the predetermined threshold, the controller performs any one of a process of displaying the preview image on the display device with the orientation unchanged and the orientation adjustment display according to the orientation of the characters according to an instruction received via the operation device.

8. The information processing device according to claim 6, wherein
the display device is a rectangular shape having a long side and a short side,
the information processing device further comprises
a rotation mechanism configured to rotate the display device between a portrait orientation in which the long side is positioned vertically and a landscape orientation in which the short side is positioned vertically; and
a detection sensor configured to detect whether the display device is in a landscape state or a portrait state, wherein
the controller performs a size adjustment display for adjusting a size of the preview image according to a display area of the display device according to an orientation of the display device detected by the detection sensor and displaying the preview image on the display device, and
the controller causes the display device to display a message for prompting a user not to rotate the display device when the orientation of the display device detected by the detection sensor does match the orientation of the preview image that becomes the portrait orientation in which characters are upright at the time execution of the orientation adjustment display.

9. The information processing device according to claim 8, wherein the controller causes the display device to display a message for prompting a user to rotate the display device when the orientation of the display device detected by the detection sensor does not match the orientation of the preview image that becomes the portrait orientation in which characters are upright at the time execution of the orientation adjustment display.

10. The information processing device according to claim 1, further comprising an operation device to which a user instruction is input, wherein
the controller
causes the display device to display a preview image with an orientation of the output target image unchanged and a predetermined operation button on the same screen, and
performs the orientation adjustment display when the controller detects a user operation with respect to the operation button via the operation device.

11. An image forming apparatus comprising:
the information processing apparatus according to claim 1; and
an image forming device configured to form an image on a sheet, wherein
the controller causes the display device to display, as the preview image, an image serving as an image formation target of the image forming device.
